(19) United States
(12) Patent Application Publication
(10) Pub. No.: US 2026/0279938 A1
(43) Pub. Date: Sep. 17, 2026

(54) An ultra-high areal loading MnO2 electrode

(71) Applicant: The Board of Trustees of the Leland Stanford Junior University, Stanford, CA (US)

(72) Inventors: Yi Cui, Stanford, CA (US); Xin Xiao, Palo Alto, CA (US); Zewen Zhang, Stanford, CA (US)

(21) Appl. No.: 19/471,708

(22) PCT Filed: Apr. 4, 2024
(86) PCT No.: PCT/US2024/023063

§ 371 Date: Oct. 2, 2025

Related U.S. Application Data
(60) Provisional application No. 63/456,877, filed on Apr. 4, 2023.

(51) Int. Cl. H01M 10/44; H01M 4/50

(52) U.S. Cl. CPC H01M 10/44; H01M 4/50; H01M 2220/10; H01M 2300/0005

(57) ABSTRACT

In rechargeable batteries having an Mn²+/MnO₂ electrode and have an aqueous electrolyte, we discovered that by tuning the operating temperature of battery cycling we can manipulate the deposited phase from ε-MnO₂ with low conductivity to γ-MnO₂ with two orders of magnitude increase in electronic conductivity. We demonstrated that the highly conductive γ-MnO₂ could be effectively exploited for ultrahigh areal loading electrode, and a normalized areal loading of 33 mAh cm⁻² was achieved within 3 hours. At a mild temperature of 50° C., cells were cycled with an ultrahigh areal loading of 20 mAh cm⁻² (1-2 orders of magnitude higher than previous studies) for over 200 cycles with only 13% capacity loss.

### FIELD OF THE INVENTION

This invention relates to rechargeable batteries, also known as secondary batteries.

### BACKGROUND

For conventional Mn²⁺/MnO₂ electrodes, utilized in manganese-hydrogen and manganese-zinc rechargeable batteries, poor electronic conductivity of electro-deposited MnO₂ is a key critical problem that limits the maximum specific areal loading, resulting in only a thin layer of MnO₂ with low areal loading (around 0.005~0.05 mAh cm⁻²) is deposited the current collector surface.

Accordingly, it would be an advance in the art to provide improved manganese-based rechargeable batteries.

### SUMMARY

We discovered that by tuning the operating temperature of battery cycling we can manipulate the deposited phase from ε-MnO₂ with low conductivity to γ-MnO₂ with two orders of magnitude increase in electronic conductivity. We demonstrated that the highly conductive γ-MnO₂ could be effectively exploited for ultrahigh areal loading electrode, and a normalized areal loading of 33 mAh cm⁻² was achieved within 3 hours. At a mild temperature of 50° C., cells were cycled with an ultrahigh areal loading of 20 mAh cm⁻² (1-2 orders of magnitude higher than previous studies) for over 200 cycles with only 13% capacity loss.

This work could be adopted into the aqueous battery based on Mn²⁺/MnO₂ electrochemistry. Especially for the promising manganese-hydrogen and manganese-zinc aqueous battery that could be possibly used for grid-scale energy storage in the future due to their environmental benignity, cost-effectiveness, and intrinsic safety.

Compared to the conventional Mn²⁺/MnO₂ electrode, our approach increased the electronic conductivity of electro-deposited MnO₂ by 2-3 orders of magnitude, which further promote the normalized areal loading of MnO₂ with 2-3 orders of magnitude (from 0.005~0.05 mAh cm⁻² to 33 mAh cm⁻²),

Compared to other doping methods to modify MnO₂ materials which only increase several folds electronic conductivity, our approach increased the electronic conductivity by 100~1000 fold. In addition, prior doping methods are hard to keep doped upon cycling since the doped atoms may dissolved into solutions, while our in-situ temperature dependent tuning technique could maintain its polymorph during cycling.

### BRIEF DESCRIPTION OF THE DRAWINGS

FIGS. 1A-B show some properties of MnO₂ polymorphs.

FIGS. 2A-E show characterization results for Mn²⁺/MnO₂ electrodes operated at ambient temperatures.

FIG. 3A schematically shows an embodiment of the invention.

FIGS. 3B-G show characterization results for Mn²⁺/MnO₂ electrodes operated at ambient and elevated temperatures.

FIGS. 4A-D show characterization results for ultrahigh areal loading Mn²⁺/MnO₂ electrodes operated at elevated temperatures, and a comparison to operation at ambient temperature.

FIGS. 5A-G show cycling performance results based on temperature-dependent MnO₂ regulation.

FIG. 6 shows further cycling performance results based on temperature-dependent MnO₂ regulation.

### DETAILED DESCRIPTION

Section A describes general principles relating to embodiments of the invention. Section B describes several detailed examples.

### A) General Principles

An exemplary embodiment of the invention is a method of operating a battery, where the method includes:
1) cycling a rechargeable battery having an aqueous electrolyte, where the rechargeable battery includes an Mn²⁺/MnO₂ electrode; and
2) selecting an above-ambient operating temperature for the battery to control a polymorph of MnO₂ that is deposited on the Mn²⁺/MnO₂ electrode during battery cycling.

The operating temperature is preferably in a range between 40° C. and 80° C. Preferably, the operating temperature is selected to provide preferential deposition of γ-MnO₂ relative to ε-MnO₂.

Preferably, the charge capacity of the Mn²⁺/MnO₂ electrode is 10 mAh/cm² or more. Preferably, the discharge capacity of the Mn²⁺/MnO₂ electrode is 10 mAh/cm² or more.

The battery can be configured for operation in a grid battery storage system, where rechargeable batteries are used to store electrical energy from the grid during times of off-peak demand in order to provide energy to the grid at peak demand times.

Suitable battery types include, but are not limited to: Mn—H₂ batteries, Mn—Zn batteries, Mn—Cu batteries, Mn—Al batteries, Mn—Pb batteries and Mn—Bi batteries.

### B) Detailed Examples

### B1) INTRODUCTION

The transition to a low-carbon economy and a sustainable future highlights the search for alternative clean energy technology. This has led to a surge in demand for advanced energy storage solutions, particularly in battery technologies with practical potentials in grid-scale applications. Despite the wide adoption of lithium-ion batteries in portable electronics and electric vehicles, the safety concerns of these organic-electrolyte based batteries are driving the pursuit of alternative stationary storage solutions. Aqueous rechargeable batteries, based on non-flammable water-based electrolytes, hold great promise due to their environmental benignity, cost-effectiveness, high power capability, much-improved tolerance again mishandling, and reasonable energy density. Additionally, the exemption of ultra-dry environment for manufacturing provides another competitive edge over the current LIB industry.

Among various aqueous battery chemistries, manganese-based redox reactions have attracted wide attention. The fact that manganese has multiple available valence states in aqueous solutions, including Mn(0), Mn(II), Mn(III), Mn(IV) and Mn(VII), has given rise to rich battery chemistries. Of all available redox couples, Mn²⁺/MnO₂ presents attractive attributes as high electrode potential (1.23 V vs. standard hydrogen electrode) and high theoretical capacity (616 mAh g⁻¹). Recently, various types of aqueous batteries with Mn²⁺/MnO₂ redox reactions have been reported for potential grid-scale energy storage, such as Mn—H₂, Mn—Zn, Mn—Cu, Mn—Al, Mn—Pb, and Mn—Bi batteries. Mn²⁺/MnO₂ electrode follows the dissolution/precipitation reaction pathway as (Eq. 1).

$${Mn}^{2 +} + 2 {H}_{2} O ↔ {MnO}_{2} ( s ) + 4 {H}^{+} + 2 {e}^{-} \qquad ( 1 )$$

Upon charging, soluble Mn²⁺ gets oxidized into solid MnO₂ and deposited onto the current collector. The maximum specific areal loading is ultimately limited by the poor electronic conductivity of MnO₂. This can be more problematic for high-rate cycling. In fact, a highly reversible Mn²⁺/MnO₂ electrode often requires a porous, high-surface-area, and electronically conducting substrate, where only a thin layer of MnO₂ is deposited to shorten the electron transport distance to guarantee the reversible electrode reactions. It is still challenging to achieve high loading in a Mn²⁺/MnO₂ electrode to realize the practical application.

Polymorphism, the ability of solid materials to crystallize into various crystal structures with the same stoichiometry, adds another dimension to functionality tuning over materials. MnO₂ is a widely investigated polymorphic inorganic material in catalysis, water desalination, and energy storage, featured by various arrangements of edge or corner-sharing [MnO₆]octahedra units. Such variations in different morph structures give rise to dramatically different chemical, physical and biological properties, having direct impact on its function properties, and thus on its technological applications.

Herein, we investigated the electrochemical performance of various MnO₂ polymorphs in Mn²⁺/MnO₂ redox reactions and determined that the primary electrochemically deposited MnO₂ phase in the acidic aqueous electrolyte is ε—MnO₂ with low conductivity. We discovered that we could tune the deposited phase of MnO₂ with temperature and exploited the highly conductive polymorphs to achieve a highly reversible and ultrahigh areal loading MnO₂ cathode for aqueous batteries. As temperature rises, the deposited phase gradually changes from ε-MnO₂ to γ-MnO₂, with over two orders of magnitude increase in conductivity. At a mild temperature of 50° C., cells were cycled with an ultrahigh areal loading of 20 mAh cm⁻² for over 200 cycles with only 13% capacity loss.

### B2) ELECTROCHEMICAL PERFORMANCE OF MnO₂ POLYMORPHS

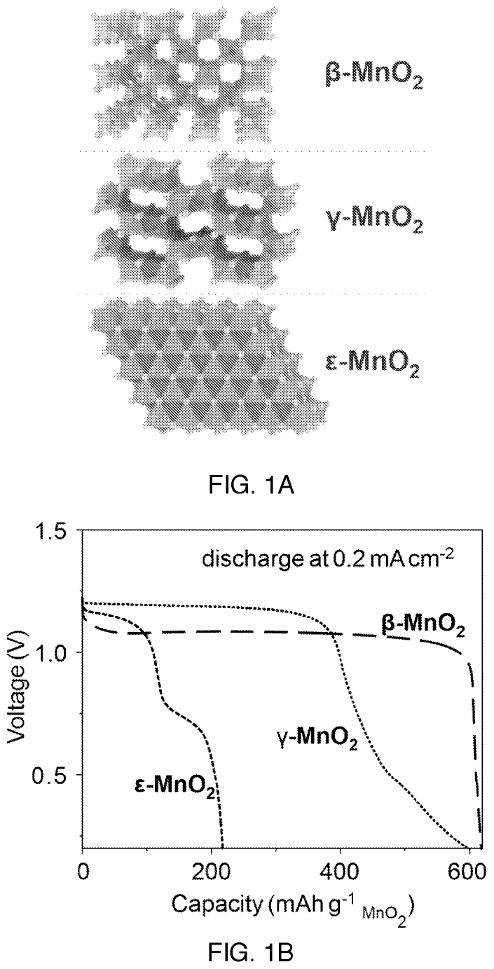

FIG. 1A schematically shows crystal structures of ε—MnO₂, γ-MnO₂, and β-MnO₂. FIG. 1B shows cell voltage profiles of ε-MnO₂, γ-MnO₂, and β-MnO₂ during discharge at current density of 0.2 mA cm⁻² in Mn—H₂ battery (mass loading: ~0.2 mAh cm⁻², electrolyte: 1 M MnSO₄+0.1 M H₂SO₄).

Typical polymorphs of MnO₂ for energy storage and other applications include α-, β-, γ-, δ-, ε-, and λ-MnO₂. These polymorphs differ in the way of interlinkage between the MnO₆ octahedra, resulting in tunnels or interlayers with various magnitudes of gaps (FIG. 1A). We synthesized all six MnO₂ polymorphs and confirmed their crystalline structures with X-ray powder diffraction (XRD). The measured electronic conductivities of MnO₂ polymorphs via the four-point probe method (in mS m⁻¹) are as follows: 111.2 (α), 974.8 (β), 403.1 (γ), 3.7 (δ), 2.0 (ε), 3.7 (λ).

Among the polymorphs, δ-, λ-, ε-MnO₂ have similar electronic conductivity around 2 mS m⁻¹, while α-, β-, and γ-MnO₂ show much better electrical conductivities about two orders of magnitudes higher, agreeing well with previous experimental reports and theoretical band gap computation. These MnO₂ polymorphs were further made into slurry-coated electrodes and cycled in an aqueous electrolyte. A 3-fold difference in specific discharge capacity was observed among all the polymorphs. Specifically, β-MnO₂, the morph with the highest electrical conductivity, delivers the highest specific capacity of 616.0 mAh g⁻¹_{MnO2}, while ε-MnO₂ delivers only 217.3 mAh g⁻¹_{MnO2}. (FIG. 1B) Polymorphs with comparable electrical conductivity as β-MnO₂, for example, γ-MnO₂, delivers a specific capacity of 597.4 mAh g⁻¹_{MnO2} (FIG. 1B), quite close to MnO₂'s theoretical capacity of 616 mAh g⁻¹_{MnO2}, showing excellent electrochemical performance. In general, the electrochemical performance of MnO₂ polymorphs in Mn²⁺/MnO₂ redox reactions follows the similar trend in their electrical conductivities, which works not only in Mn—H₂ battery, but also in Mn—Zn battery. FIG. 1B shows the typical discharge curves of ε-MnO₂, γ-MnO₂, and β-MnO₂ electrodes.

### B3) PRIMARY PHASE OF ELECTROCHEMICALLY DEPOSITED MnO₂ IN AQUEOUS ELECTROLYTE

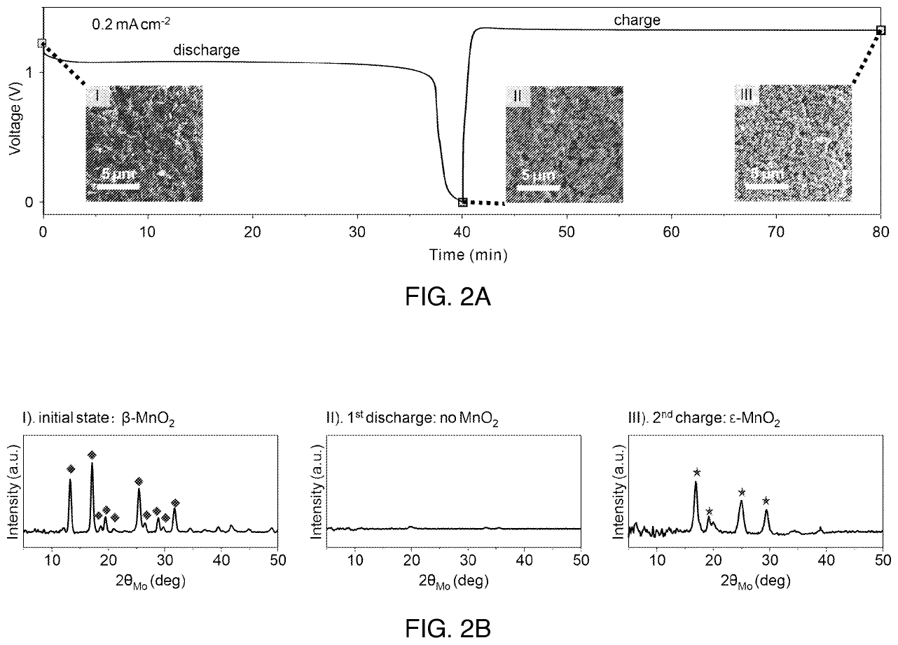

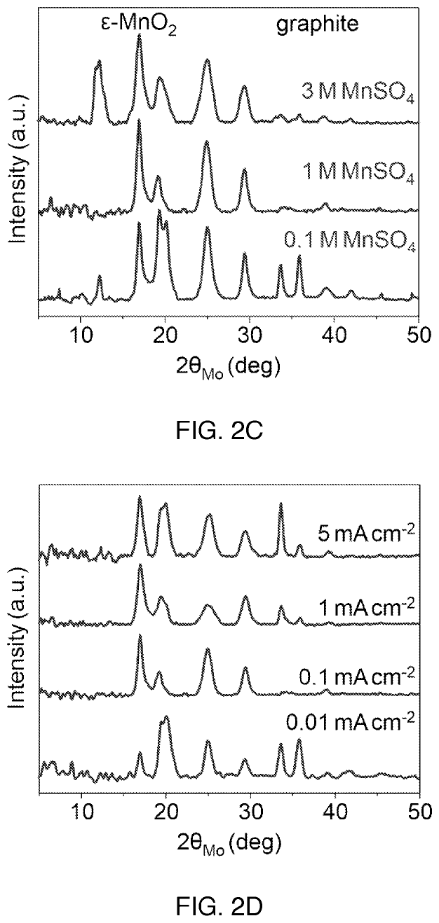

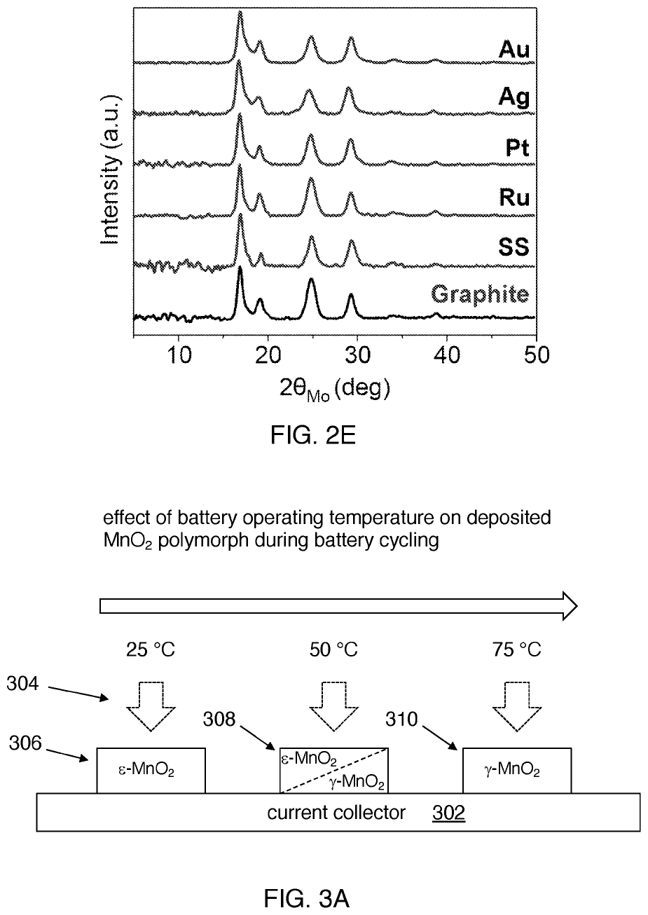

FIG. 2A shows the discharge curve of β-MnO₂ based cathode and the following charge curve. The inset SEM images show the cathode morphology at the initial state, after 1^{st} full discharge, and after 1^{st} charge, respectively. FIG. 2B shows the corresponding XRD spectra of the cathode at different states in FIG. 2A. The diamond and star symbols indicate the diffraction peaks of β-MnO₂ (JCPDS card 00-024-0735) and ε-MnO₂ (JCPDS card 00-030-0820), respectively. FIG. 2C shows XRD spectra of MnO₂ deposited in electrolytes with different Mn²⁺ concentrations. FIG. 2D shows XRD spectra of MnO₂ deposited at various current density in 1 M MnSO₄+0.1 M H₂SO₄ electrolyte. FIG. 2E shows XRD spectra of MnO₂ deposited on different substrates in 1 M MnSO₄+0.1 M H₂SO₄ electrolyte. “SS” denotes stainless steel.

Despite the significant difference in electrochemical performance of various MnO₂ polymorphs, the primary phase, or phases of electrochemically deposited MnO₂ in aqueous electrolytes, remain largely uninvestigated for secondary mild acidic aqueous Mn²⁺/MnO₂ batteries. Here, we found that the primary phase of electrochemically deposited MnO₂ in common aqueous electrolytes is ε-MnO₂ (FIGS. 2A-E). The lowest electronic conductivity among all polymorphs makes ε-MnO₂ the least favorable for electrochemical reactions. The high performance of ε-MnO₂ in previous reports arose from a low specific normalized areal loading (0.005-0.05 mAh cm⁻²) on current collector. However, high energy density and low-cost battery entails practically high areal loading of active materials with improved reversibility. Specifically, cycling with MnO₂ polymorphs of higher electrochemical reversibility is the key. This becomes increasingly critical for the Mn²⁺/MnO₂ electrode as new solid MnO₂ forms in every cycle, which directly impact the overall electrochemical performance of the battery. The electrode with as-synthesized β-MnO₂ completely dissolved during the first discharge cycle. Both scanning electron microscope (SEM) and XRD (FIGS. 2A-B) confirmed the existence of β-MnO₂ at the initial state and no XRD peak of β-MnO₂ was detected after discharge. After the second charge cycle at 0.2 mA cm⁻² for 40 min, the newly deposited phase became ε-MnO₂ (FIGS. 2A-B).

Polymorphism can be affected by the details of crystallization. The solvent in all aspects affects the nature of the polymorph, including concentration, inhibiting or promoting certain growth patterns. We deposited MnO₂ to 1 mAh cm⁻² in electrolytes with various Mn²⁺ concentrations, from 0.1 M to 3 M, and found that the ε-MnO₂ with low conductivity was the primary deposited phase (FIG. 2C). Despite the increase of current density from 0.01 mA cm⁻² to 5 mA cm⁻², the primary polymorph deposited remained to be ε-MnO₂ with the characteristic 2θ peaks (Mo source) at 16.8°, 19.2°, 25.0°, 29.4° (JCPDS card 00-030-0820) (FIG. 2D). Furthermore, we checked the effect of substrate. On Au, Ag, Pt, Ru, stainless steel (SS), and graphite, substrates that are compatible with Mn²⁺/MnO₂ redox reactions, the deposited phases were all ε-MnO₂ (FIG. 2E). Note that the above experiments were carried out on bare current collectors without preloaded MnO₂. In addition, we discovered that the growth of MnO₂ cannot be altered by growing on a certain morph. When the electrode with preloaded β-MnO₂ was charged, the increasing peak intensity at 29.4° (ε-MnO₂) and the decreasing peak at 13.4° (β-MnO₂) indicated that the primary deposited MnO₂ phase was still ε-MnO₂. Although the above analysis was done in Mn—H₂ battery, the same observation is true in Mn—Zn battery.

### B4) POLYMORPH TUNING OF THE ELECTROCHEMICALLY DEPOSITED MnO₂ VIA TEMPERATURE

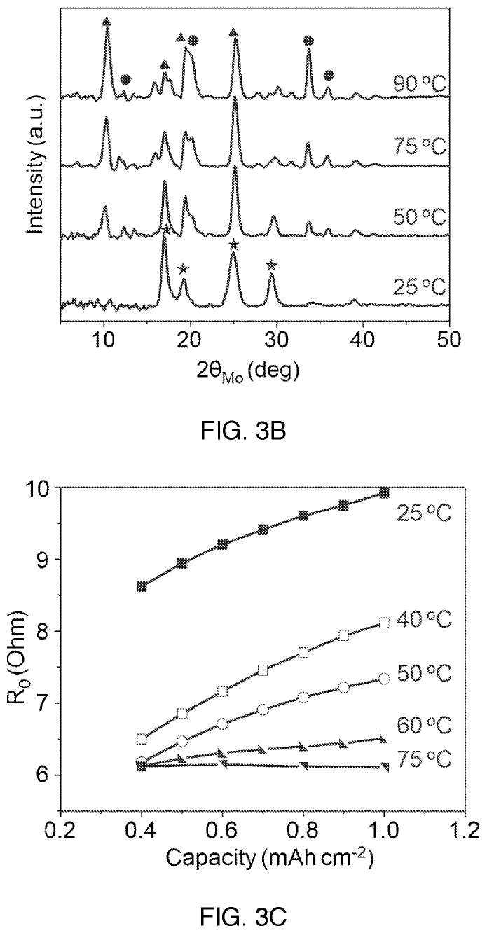

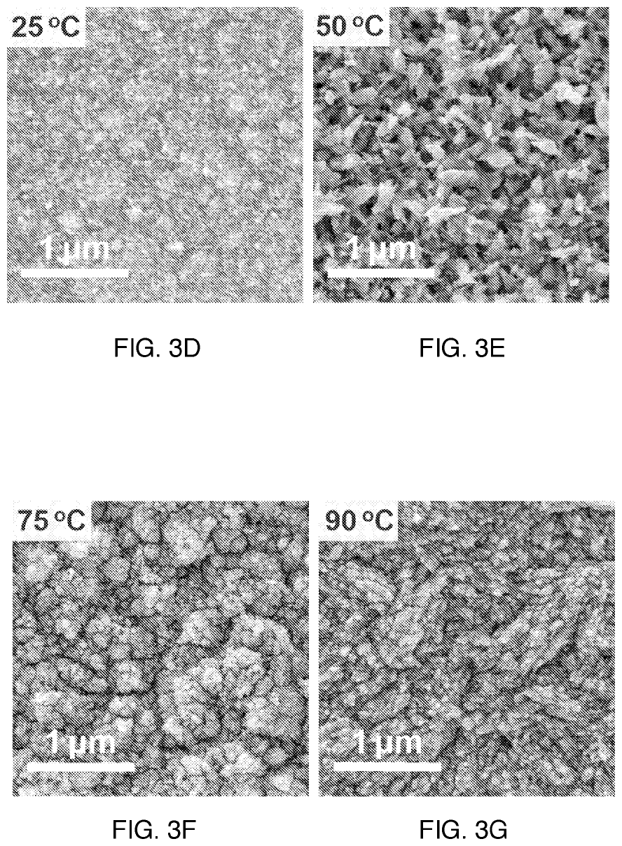

FIG. 3A is a schematic of deposited MnO₂ polymorph transition as a function of temperature. FIG. 3B shows XRD patterns of deposited MnO₂ at different temperatures. Stars, triangles, and circles refer to ε-MnO₂, γ-MnO₂, and graphite, respectively. FIG. 3C shows the cell resistance as a function of the deposited capacity of MnO₂ at different temperatures. Current collector: graphite foil. The battery was first charged at 1.6 V to certain capacity and rested for 5 mins before the electrochemical impedance spectroscopy (EIS) measurement. Note that the resistance R₀ was after proton concentration correction, such that the slopes of these curves reflect the electronic resistance increment per 1 mAh cm⁻² MnO₂ deposited. FIGS. 3D-G show the SEM images of deposited MnO₂ on a graphite foil current collector at different temperatures (0.1 mA cm⁻² to 1 mAh cm⁻²).

Since the lattice energy differences between polymorphs are usually small, we hypothesize that it is possible to tune the polymorphs by slightly adjusting the temperature of the solvent in which the crystallization is carried out. Layer-to-tunnel (L-T) transition was observed in Mg²⁺-buserite after hydrothermal treatment at 220° C., confirming the temperature-dependent polymorph manipulation. Here we cycled the battery at different temperatures to alter the deposited MnO₂ polymorphs (FIGS. 3A-G). The batteries were rested 30 mins before cycling to ensure the temperature equilibrium. We found that as the temperature increased from 25° C. to 90° C., there was a transition in deposited phase from ε-MnO₂ to γ-MnO₂, as shown on FIG. 3A.

At 25° C., ε-MnO₂ (306) was the only morph deposited, at 50° C., there was a mixture of ε-MnO₂ and γ-MnO₂ (308), while at 90° C. γ-MnO₂ (310) was the only morph deposited. The other feature on FIG. 3A is current collector 302, and MnO₂ deposition due to battery cycling in operation is schematically shown with arrows 304. Though in the industry and research field, preparation of electrolytic manganese dioxide (mainly γ-MnO₂) at high temperature has been reported for the application in alkaline batteries, lithium manganese primary batteries and supercapacitors, this temperature dependent polymorphism tunning is seldomly reported for cycling Mn based aqueous battery under a two-electron transfer mechanism. In the corresponding XRD spectra (FIG. 3B), the increasing peak intensities at 2θ=10.0° (Mo sources) and the decreasing peak intensities at 2θ=29.4° (Mo sources) were in accord with such crystallographic transition. The morphological changes of the deposited MnO₂ at different temperatures shown in FIGS. 3D-G transitioned from a round-shaped particle at room temperature (25° C.) to a more needle-shaped overall structure at higher temperatures. Such morphology and phase transition under various temperatures were also confirmed in Mn—Zn battery.

The electronic conductivity of γ-MnO₂ is two orders of magnitude higher than ε-MnO₂. Such a less resistive deposited phase enables higher areal capacity loading in principle. We measured the ohmic resistance of the deposited MnO₂ layer as a function of the deposited capacity, where the ohmic resistance from electrolyte/current collectors and proton concentration were corrected beforehand. The slope reflects the electronic resistivity of the deposited phase, where a smaller slope indicates a smaller resistivity. As shown in FIG. 3C, the slope gets smaller as the temperature increases. Such change corresponds well with the observed transition from the more resistive morph ε-MnO₂ to a more conductive morph γ-MnO₂.

### B5) ULTRAHIGH-LOADING MANGANESE-BASED ELECTRODE VIA POLYMORPH MANIPULATION

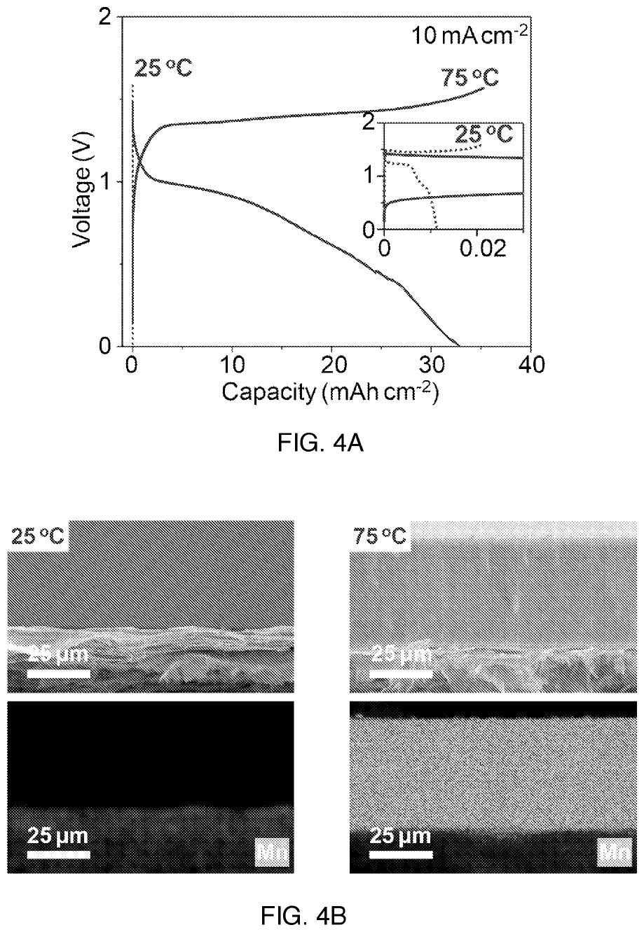

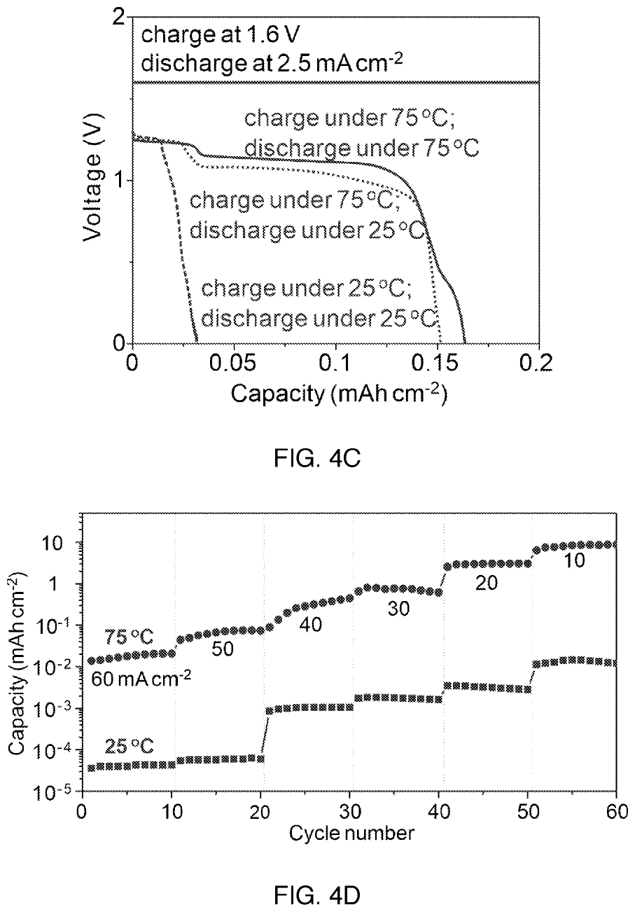

FIG. 4A shows the charge-discharge curve in Mn—H₂ battery using cathode graphite foil under different temperature using large volume of electrolyte (100 mL 1 M MnSO₄+0.1 M H₂SO₄). The inset is the zoom-in diagram of areal capacity up to 0.03 mAh cm⁻². FIG. 4B shows the cross-sectional SEM images (top) and the corresponding EDS (energy dispersive X-ray spectroscopy) mapping (bottom) of the deposited MnO₂ layer on graphite foil after 1^{st} charge cycle at 10 mA cm⁻², scale bar: 5 μm. Two temperatures are considered: 25° C. (left) and 75° C. (right). FIG. 4C shows the discharge curve under different charge/discharge temperatures. FIG. 4D shows the rate capability of the MnO₂ deposited at 25° C. and 75° C.

To demonstrate the advantage of polymorph tuning in Mn²⁺/MnO₂ reactions, we compared the total areal capacity achievable with a constant current (10 mA cm⁻²) and a voltage cutoff (1.6 V) at different temperatures. Notice that a flat graphite foil was used as the current collector as a model system to avoid the normalization of high surface areas in other 3-D current collectors. FIG. 4A shows the typical charge/discharge curves of batteries at 25° C. and 75° C. at 10^{th} cycle. The total charge capacity of around 35 mAh cm⁻² with a discharge capacity of 33 mAh cm⁻² was achieved at 75° C. In contrast, a charge capacity of 0.02 mAh cm⁻² with a discharge capacity of 0.01 mAh cm⁻² was achieved at 25° C. A 2000-fold increase in the areal mass loading of MnO₂ was observed. Such drastic improvement demonstrated the power of polymorph tuning in building ultra-high loading Mn-based electrodes.

FIG. 4B shows the cross-sectional SEM images and corresponding EDS mapping of the deposited MnO₂ layer at 25° C. and 75° C. after 1^{st} cycle charged. The thickness (~45 μm) of the deposited MnO₂ at 75° C. is remarkably larger than the thickness (<1 μm) of MnO₂ at 25° C. To show that the increase in discharge capacity was the result of a more favorable morph instead of other factors influenced by temperature, such as the ionic conductivity in the electrolyte, we charged the battery at 75° C. to deposit more conductive γ-MnO₂, and then cooled down the battery to room temperature for discharge. A comparable CE (Coulomb efficiency) was obtained compared with CE of cycled cells at 75° C. (75.7% vs. 81.5%). In contrast, batteries both charged and discharged at 25° C. showed a CE of only 15.7% (FIG. 4C). These results indicated that the increased conductivity of a more favorable morph contributed substantially to the CE increase. Moreover, these findings also highlight the need to maintain a comparatively high operating temperature while depositing MnO₂ to ensure a high capacity. We also show that such 2-3 orders of magnitude increase in the areal loading of MnO₂ was maintained over a wide current density range (FIG. 4D).

### B6) MN—H₂ CELL PERFORMANCE WITH HIGH AREAL MnO₂ LOADING

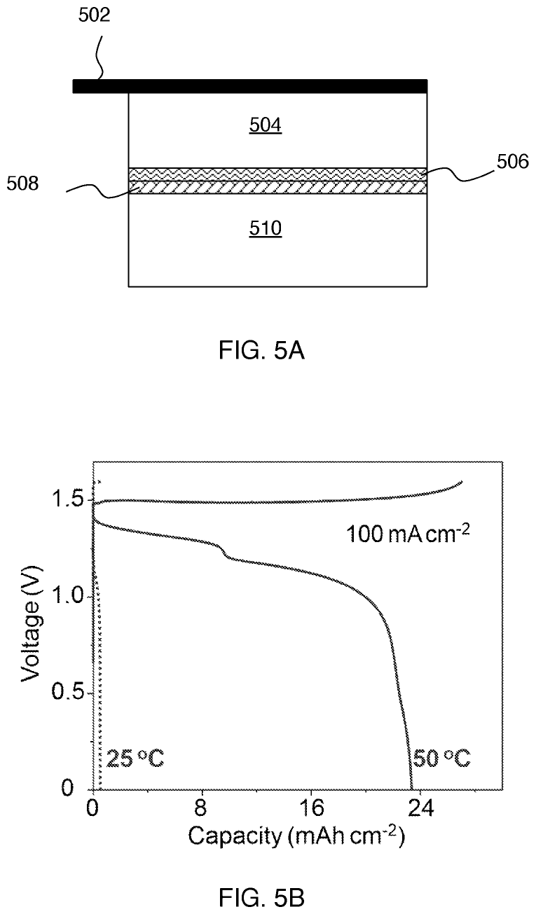

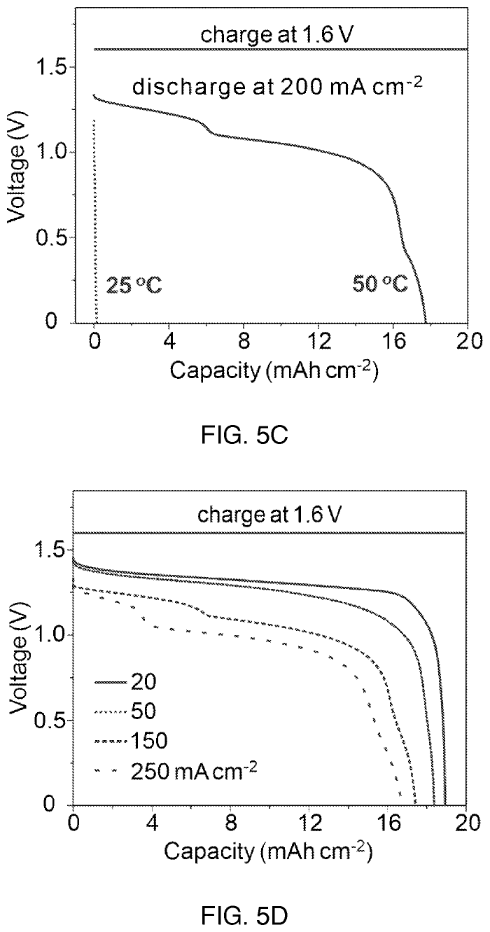

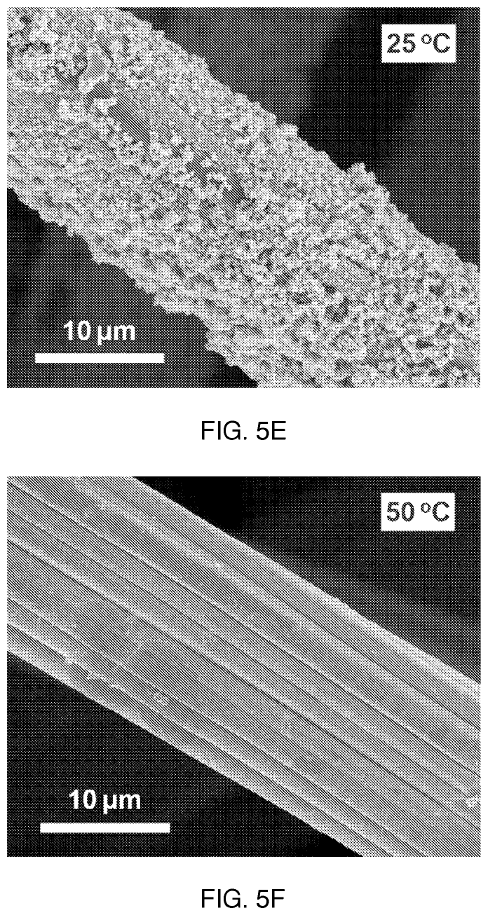

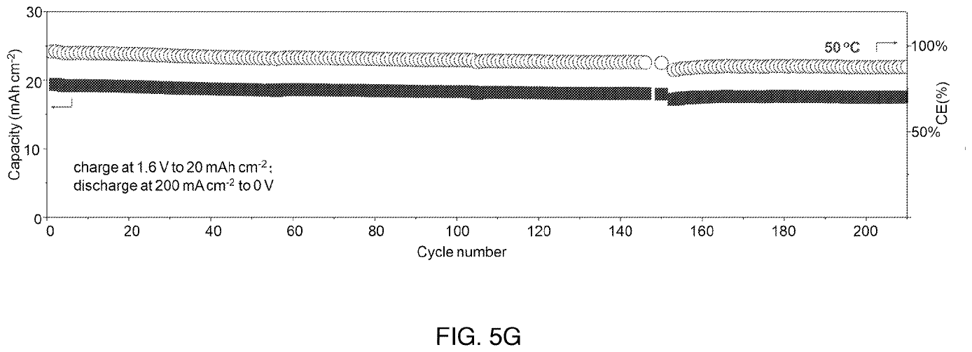

FIG. 5A is a schematic diagram of Mn—H₂ cell using carbon felt as cathode current collector. Here 502 is the top electrode, 504 is the carbon felt including the electrolyte (3M MnSO₄+1 M H₂SO₄), 506 is a glass fiber separator, 508 is a platinum gas diffusion electrode, and 510 is a gas chamber for receiving wet hydrogen gas. FIG. 5B shows the 1^{st} cycle difference by temperature under Galvanostatic charge/discharge profile (100 mA cm⁻²). FIG. 5C shows the temperature effect of Mn—H₂ battery under potentiostatic charge at 1.6 V to 20 mAh cm⁻², then discharge at 200 mA cm⁻² to 0 V. FIG. 5D shows the discharge curve of Mn—H₂ battery at 50° C. under different current densities. FIGS. 5E, 5F show the morphologies of the carbon felt after 1^{st} cycle discharge from FIG. 5C at 25° C. and 50° C. respectively. FIG. 5G shows the long cycle performance of Mn—H₂ under a mass loading of 20 mAh cm⁻² (charged at 1.6 V), and discharged at 200 mA cm⁻², followed by a deep discharge current of 20 mA cm⁻² in every cycle.

To evaluate the cell performance of Mn²⁺/MnO₂ electrode with polymorph tuning in a more applicable setting, we tested the batteries at 50° C. in a Mn—H₂ battery setup as schematically shown in FIG. 5A. Two different charging protocols were applied here. FIG. 5B shows the result of charging with constant current to compare the area mass loading under 100 mA cm⁻². For room temperature without phase regulation, the discharged MnO₂ was 0.51 mAh cm⁻², with a comparison to the discharged capacity of 23.4 mAh cm⁻² after phase regulation (50° C.), implying two orders of magnitudes increment of MnO₂ areal loading. FIG. 5C shows the result of charging with constant voltage to a fixed capacity to compare the coulombic efficiency. Both cells were charged under 1.6 V to 20 mAh cm⁻², the discharged capacity at 200 mA cm⁻² was only 0.15 mAh cm⁻² under 25° C., substantially lower than 17.7 mAh cm⁻² under 50° C. The corresponding SEM images of the carbon felt current collector after discharge showed that a nontrivial amount of MnO₂ deposit remained under 25° C., while little could be observed under 50° C. (FIGS. 5E-F). The improved performance could also be observed under other current densities.

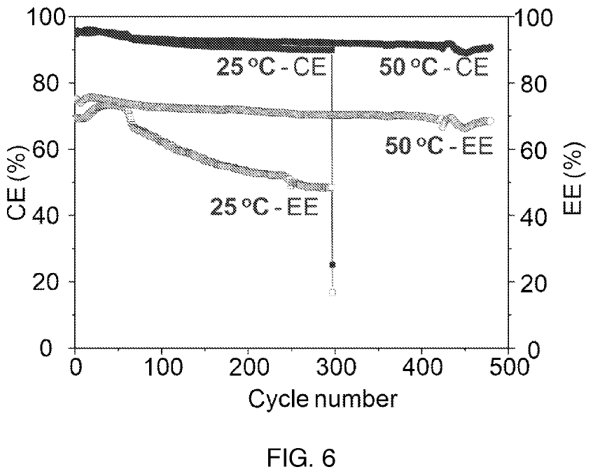

FIG. 6 shows the cycle performance of Mn—H2 battery with an areal loading of 10 mAh cm⁻². Cycling protocol: Charged at 1.6 V to 10 mAh cm⁻², then discharged at 50 mA cm⁻² to 0 V, deep discharge at 0 V with a cutoff current density of 0.5 mA cm⁻². Carbon felt ∥ Pt, electrolyte: 1 mL 1 M MnSO₄+1 M H₂SO₄.

We further tested the long-term cycle performance with two high areal capacities, 10 mAh cm⁻² and 20 mAh cm⁻². FIG. 6 shows the cycling data for 10 mAh cm⁻² loading under 25° C. and 50° C. An extended cycle life of 450 cycles under 50° C. was achieved, compared to 296 cycles for 25° C. More importantly, a much faster overpotential increase was observed for 25° C. due to the irreversible loss of available conductive surface from incomplete MnO₂ dissolution. Post-mortem investigation on the 100-cycled cathode indicated a less remaining MnO₂ particles on carbon fiber for battery cycling at higher temperature; and no carbon expanding, nor carbon exfoliation were detected, suggesting the stability of the carbon current collector during cycling. With a more concentrated Mn²⁺ electrolyte (3 mol L⁻¹), a higher areal capacity loading of 20 mAh cm⁻² could be achieved, with a cycle life of over 200 cycles and only 13% capacity loss. It should be noted that no comparable high areal loading was reported before previously in Mn²⁺/MnO₂ based aqueous batteries with conventional separator.

### B7) CONCLUSION

This work investigated the electrochemical performances of MnO₂ polymorphs for Mn²⁺/MnO₂ electrode in acidic aqueous electrolytes. The primary electrochemically deposited phase in the conventional aqueous electrolyte is ε-MnO₂ which has a lowest electronic conductivity and thus poor electrochemical performance. We demonstrated temperature as an effective tuning knob in polymorph tuning to manipulate the deposited phase of MnO₂. By a mild increase in temperature, the electrochemically deposited MnO₂ phase transitions from ε-MnO₂ to γ-MnO₂ whose electronic conductivity is high enough to enable ultrahigh areal loading of MnO₂ cathode with superior rate capability and reversibility. As a proof-of-concept, the battery can be cycled with 20 mAh cm⁻² for over 200 cycles with only 13% capacity decay. Such ultrahigh areal loading cathode substantially lowers the overall cost and promises the practical application of manganese-based batteries for grid-scale energy storage. We expect this polymorphism tuning to be generally applicable to dissolution/precipitation battery chemistry to engineering high energy density aqueous battery and beyond.

### B8) METHODS

### B8.1) Materials Synthesis

MnO₂ polymorphs were synthesized via hydrothermal methods. XRD spectra of corresponding MnO₂ polymorphs match well with the standard PDF (powder diffraction file) card, confirming the crystal structures of the obtained MnO₂. The corresponding detailed synthesis procedures are listed as follows.

B8.1.1) α-MnO₂ (JCPDS: 00-044-0141): 1.26 g of KMnO₄ and 0.51 g of MnSO₄·H₂O were dissolved in 80 mL deionized water (DI water) and stirred for 30 mins. The mixture solution was transferred into a Teflon-lined stainless-steel reactor. The autoclave was then heated to 160° C. with a ramp up rate of 10° C. min⁻¹ and held for 12 h. After cooling down to room temperature, the solid precipitates were washed with DI water for 8 times and collected with centrifuging to remove the residual salts. The powders were dried overnight at 80° C. and then calcined at 300° C. for 4 h to yield a brown powder.

B8.1.2) β-MnO₂ (JCPDS: 00-024-0735): 1.28 g of NaMnO₄·H₂O and 2.03 g of MnSO₄H₂O were dissolved in 40 mL DI water and stirred for 30 mins. The mixture solution was transferred to a Teflon-lined stainless-steel reactor. The autoclave was then heated to 160° C. with a ramp up rate of 10° C. min⁻¹ and held for 12 h. After cooling down to room temperature, the solid precipitates were collected after centrifuging and washing with DI water 8 times to remove the residual salts. The powder was dried overnight at 80° C.

B8.1.3) γ-MnO₂ (JCPDS: 00-014-0644): 1.35 g of MnSO₄·H₂O was firstly dissolved in 30 mL DI water and 1.83 g of (NH₄)₂S₂O₈ were added to the solution. After stirring for 30 min, the mixture solution was then water-bathed with stirring (800 rpm) at 90° C. After cooling down to room temperature, the solid precipitates were collected after centrifuging and washing with DI water for 8 times to remove the residual salts. The powder was dried overnight at 80° C.

B8.1.4) δ-MnO₂ (JCPDS: 01-073-7867): 3 g of KMnO₄ was firstly dissolved in 50 mL DI water and 20 mL 1.4 mol L⁻¹ glucose aqueous solution was added. After a two-hour reaction at room temperature, a brown gel was obtained. The gel was dried at 110° C. for 24 h and then calcined at 400° C. for 2 h. After cooling down to room temperature, the solid precipitates were collected after centrifuging and washing with DI water 8 times to remove the residual salts. The powder was dried overnight at 80° C.

B8.1.5) ε-MnO₂ (JCPDS: 00-030-0820). 2.15 g of Fe(NO₃)₃·9H₂O was firstly dissolved in 100 mL DI water and 3.45 g of MnCO₃ was added. The solution was stirred for 30 mins. Next, 2 mL concentrated H₂SO₄ was added, followed by the addition of 6.85 g of (NH₄)₂S₂O₈. Finally, 50 mL DI water was added. After stirring for 30 mins, the solution was transferred to a Teflon-lined stainless-steel reactor. The autoclave was then heated to 110° C. with a ramp-up rate of 10° C. min⁻¹ and held for 3 h. After cooling down to room temperature, the solid precipitates were collected after centrifuging and washing with DI water 8 times to remove the residual salts. The powder was dried overnight at 80° C.

B8.1.6) A-MnO₂ (JCPDS: 00-044-0992): LiMn₂O₄ was firstly synthesized as the precursor of A-MnO₂. Briefly, 1.224 g of Mn(CH₃COO)₂·4H₂O and 0.17 g of LiNO₃ were dissolved in 10 mL DI water. The 10 mL aqueous solution contained 2.88 g of citric acid and 0.90 g of urea was added. 2 mL nitric acid was then added. The solution was kept under stirring for 5 min. The solution was then heated and kept at 80° C. to remove all the solvent for 3 days. The remaining precipitate was dried at 170° C. for 12 h and calcined at 350° C. for 12 h to become a gray powder. The as-obtained LiMn₂O₄ was mixed with 22 mL DI water, followed by adding 28 mL 0.1 mol L⁻¹ HNO₃. The mixture was then stirred and sonicated for 2 hours. The solid precipitates were filtrated and washed with DI water 8 times to remove the residual salts. The powder was dried overnight at 80° C.

### B8.2) Electrical Conductivity Measurement

Four-point probe method was used to measure the electronic conductivities of MnO₂ polymorphs. Specifically, 0.2 g MnO₂ powder was weighted and pressed under 2 ton cm⁻² for 5 min into a pellet with a 1 cm² circle and 1 mm thickness. The thickness of each pellet was measured by a slide caliper. Next, four copper wires were connected to the pellet with the silver paste. The voltage responses of two points (i.e. V_{1,2}) were recorded while applying different current to the other two points (i.e. I_{3,4}) using Keysight B1500A Semiconductor Device Analyzer. The resistance R_{12, 34} can be calculated by linear fitting the V_{1,2}~I_{3,4} curve. Likewise, R_{23, 14} can also be obtained by switching the points. The resistivity of the pellet can be calculated by the following equation:

$${e}^{- π \cdot {R}_{12 , 43} \cdot d / ρ} + {e}^{- π \cdot {R}_{23 , 14} \cdot d / ρ} = 1 \qquad ( 2 )$$

where d (cm) refers to the thickness of the pellet. The electrical resistance ρ (Ω·cm) is the inverse of the electrical conductivity σ (S cm⁻¹). We use MATLAB software to solve this implicit equation to obtain the value for p.

### B8.3) Electrochemical Measurements

To make different MnO₂ coated cathodes, 240 mg MnO₂ was mixed with 80 mg poly(vinylidene fluoride) (PVDF) and 80 mg Ketjenblack EC600JD carbon black in a quartz mortar and ground for 15 min. After being transferred into a 20 mL glass vial and added with 4 mL dimethylacetamide, the as-obtained slurry was kept stirring overnight and cast onto a graphite foil with doctor blade, followed by vacuum drying overnight at 70° C. The coating amount of MnO₂ was quantified by inductively coupled plasma mass spectrometry after dissolving in HCl solution.

Unless specified otherwise, in Mn—H₂ battery, flat graphite foil was used as the cathode-free current collector (0.5 cm²), and 1 mg cm⁻² Pt/C (40% Pt) on carbon paper (also named as gas diffusion electrode, GDE) (Fuel cell earth Co. EP401) was used as anode electrode with hydrogen flow rate of 5 mL min⁻¹. The electrolyte contains 100 mL of 1 mol L⁻¹ MnSO₄ and 0.1 mol L⁻¹ 0.1 M H₂SO₄ was used to ensure a sufficient supply of protons and Mn²⁺ for MnO₂ deposition and discharge. The cathode-to-anode distance is 1.5 mm without a separator. In Mn—Zn battery, graphite foil (0.5 cm²) was used as the cathode-free current collector, and zinc plate was used as the anode, in the experiment with pre-coated MnO₂ cathode, 150 μL of 1 mol L⁻¹ ZnSO₄ and 0.1 mol L⁻¹ 0.1 M H₂SO₄, was used as the electrolyte; while in the experiments of the primary phase study, 700 μL 1 M MnSO₄+1 M ZnSO₄ was applied.

Higher temperature indeed changed the deposited MnO₂ phase but could also increase the ion-mobility in the electrolyte. To confirm that the better battery performance is mainly due to the phase manipulation rather than ion-mobility, the battery was charged at high temperature to form the more conductive phases, then discharged at room temperature to exclude the effect of ionic mobility in Mn—H₂ battery. 150 uL 1 M MnSO₄+0.1 M H₂SO₄ was used as the electrolyte to ensure fast cooling.

Long cycle performance evaluation was carried out by using 0.5 cm² carbon felt (6.13 mm thickness, 99.0%, Alfa Aesar) as the cathode-free current collector, and Pt gas diffusion electrode as the anode electrode. Titanium foil (0.032 mm thick, 99.7%, Alfa Aesar) was used to connect both cathode and anode electrode to potentiostat workstation (FIG. 5A), glassy fiber was used as the separator. Battery was charged at 1.6 V to 20 mAh cm⁻², then discharged at 200 mA cm⁻² followed by a deep discharge at 20 mA cm⁻², and then held at 0 V until the current is lower than 0.5 mA cm⁻². The cutoff voltage for discharge is 0 V. The discharged capacity includes both the discharged capacity at −200 mA cm⁻² and −20 mA cm⁻² since the discharge plateau of −20 mA cm⁻² could still be maintained at ~1.2 V vs. SHE (standard hydrogen electrode)).

Please note that all the chemicals used were purchased from Sigma-Aldrich unless specified. Regular coin cell is not appropriate for the Mn²⁺/MnO₂ based battery because the acid electrolyte could dissolve the coin cell. All experiments related to temperature control require 30 min-holding at desired temperatures before testing. All the electrochemical experiments were recorded by VMP3 potentiostat (BioLogic). And the battery was running under 25° C. unless specified.

### B8.4) Materials Characterizations

SEM (scanning electron microscope) images are obtained with Thermo Fisher Scientific Apreo S LoVac scanning electron microscope under accelerating voltage of 5 kV. To minimize the background signal from the substrates, a thin Kapton tape (25.4 μm thickness) was used to adhere to the as-deposited MnO₂ layer for the X-ray diffractometer (XRD) measurement. Mo radiation was selected as the high bright light source for XRD (Bruker D8) with an exposure duration of 300 s and a resolution of 0.1 degree.

### B8.5) Impedance Measurement on the Mn—H₂ Battery by Different Capacity Loading

The purpose of measuring the impedance of Mn—H₂ battery is to confirm the lower electronic conductivity of the deposited MnO₂ phases under higher temperatures. Acrylic sheet and rubber were purchased from McMaster-Carr and laser-cut to fabricate a cell having electrode area 0.5 cm², where 1 mg cm⁻² Pt/C (40% Pt) on carbon paper (also named as gas diffusion electrode, GDE) (Fuel cell earth Co. EP401) was used as the counter/ref electrode, and graphite foil (0.13 mm thickness, Alfa Aesar) was used as the working electrode. The distance between the counter and working electrode was 1.5 mm. Electrolyte contained 150 μL 1 M MnSO₄+0.1 M H₂SO₄ and no separator was applied.

The electrochemical impedance spectroscopy was recorded using VMP3 potentiostat (BioLogic). After the cell was charged to a certain capacity under 1.6 V and rested for 5 min to eliminate the concentration polarization, the impedance was monitored with 10 mV of AC signal in the frequency range of 1 MHz to 200 mHz. The ohmic resistance R₀ could be divided into three parts:

$${R}_{0} = {R}_{e l e c trolyte} + {R}_{w i r e , c u rrent collectors} + {R}_{M n {O}_{2}} \qquad ( 3 )$$

Where R_{wire, current collectors} are constant during the charging process. During the charging process, Mn²⁺ was consumed while MnO₂ layer was formed and proton was generated. Since the maximum charged capacity of MnO₂ (1 mAh cm⁻²) only possessed <5% of the total Mn in the electrolyte and the thickness of 1 mAh cm⁻² MnO₂ is about 10 μm which is far less than the distance between the cathode and anode (1.5 mm), the ohmic resistance could be hardly affected by Mn²⁺ and SO₄²⁻ concentration variation and distance change between cathode and anode electrode during charging. However, the resistance decrease caused by proton concentration increasing during charging is significant. By changing electrolyte with different proton concentrations, the effect of proton concentration was corrected, such that the increment of R₀ (corrected) (FIG. 3C) was mainly attributed by the non-conductivity of deposited MnO₂ layer, meaning that larger slope in FIG. 3C indicated a larger electronic resistance of the deposited MnO₂ layer.

1. A method of operating a battery, the method comprising:
cycling a rechargeable battery having an aqueous electrolyte, wherein the rechargeable battery includes an Mn²⁺/MnO₂ electrode;
selecting an above-ambient operating temperature for the battery to control a polymorph of MnO₂ that is deposited on the Mn²⁺/MnO₂ electrode during the cycling.

2. The method of claim 1, wherein the operating temperature is in a range between 40° C. and 80° C.

3. The method of claim 1, wherein the operating temperature is selected to provide preferential deposition of γ-MnO₂ relative to ε-MnO₂.

4. The method of claim 1, wherein a charge capacity of the Mn²⁺/MnO₂ electrode is 10 mAh/cm² or more.

5. The method of claim 1, wherein a discharge capacity of the Mn²⁺/MnO₂ electrode is 10 mAh/cm² or more.

6. The method of claim 1, wherein the battery is configured for operation in a grid battery storage system.

7. The method of claim 1, wherein the battery is selected from the group consisting of: Mn—H₂ batteries, Mn—Zn batteries, Mn—Cu batteries, Mn—Al batteries, Mn—Pb batteries and Mn—Bi batteries.
